(19) United States
(12) Patent Application Publication
(10) Pub. No.: US 2018/0109855 A1
(43) Pub. Date: Apr. 19, 2018

(54) APPARATUS AND METHOD FOR PROCESSING OF PHOTONIC FRAME

(71) Applicant: ELECTRONICS AND TELECOMMUNICATIONS RESEARCH INSTITUTE, Daejeon (KR)

(72) Inventor: Bup Joong KIM, Daejeon (KR)

(21) Appl. No.: 15/609,768

(22) Filed: May 31, 2017

(30) Foreign Application Priority Data
Oct. 18, 2016 (KR) 10-2016-0135046

(51) Int. Cl. H04Q 11/00

(52) U.S. Cl. CPC H04Q 11/0003; H04Q 2011/0088

(57) ABSTRACT

A photonic frame processing apparatus for transmitting and receiving a photonic frame in an optical network includes a processor configured to convert data received by a first node among a plurality of nodes included in a predetermined number of node groups in a network into a first frame in a photonic frame structure, and a communicator configured to transmit the first frame to a destination node of a destination group among the node groups by changing an output optical wavelength of at least one transmission port based on destination information of the converted first frame, wherein the communicator is configured to transmit the first frame to the destination node through a relay configured to classify an optical signal for each wavelength between the predetermined number of the node groups and relay the optical signal to a destination.

### CROSS-REFERENCE TO RELATED APPLICATION(S)

This application claims the priority benefit of Korean Patent Application No. 10-2016-0135046, filed on Oct. 18, 2016, in the Korean Intellectual Property Office, the disclosure of which is incorporated herein by reference for all purposes.

### BACKGROUND

### 1. Field

One or more example embodiments relate to a processing technology of a photonic frame, and more particularly, to an apparatus and method of receiving and transmitting a photonic frame in an optical network.

### 2. Description of Related Art

As network technology develops, IT resources existing in a network environment may be provided as information technology (IT) services for companies or individuals. A remote cloud server may store local information of a greater number of companies and individuals, and data interworking between terminals may be performed based on data stored in a server. A cloud computing technology and service for providing new information that an individual desires by processing individual and public data stored in a server may also be actively supplied. As the number of such IT services being supplied increases, a size and performance of a cloud server must be increased, and accordingly a cost of operating a server in a data center may increase. When the size of the server in the data center increases, a number of network nodes required for connecting servers and the Internet may also increase and accordingly connection complexity may increase.

Most IT enterprise data centers currently have hundreds of thousands of servers and tens of thousands of network nodes, and the numbers of servers and network nodes are expected to grow over time. More servers may require more physical space in the data center, and lead to more power consumption and data traffic. Also, where an existing datacenter network is provided by electric switches and routers, expandability and energy efficiency may be reduced due to low resource utilization and high deployment costs, and network delay time may increase because the server data will need to pass through multiple electric switches and routers.

To achieve improvements in these areas, a network technology for enhancing expandability and energy efficiency and for reducing delay time and deployment cost while maintaining connection compatibility with an existing server or a terminal by the network in the data center may be required.

### SUMMARY

According to an aspect, there is provided a photonic frame processing apparatus including a processor configured to convert data received by a first node among a plurality of nodes included in a predetermined number of node groups in a network into a first frame in a photonic frame structure, and a communicator configured to transmit the first frame to a destination node of a destination group among the node groups by changing an output optical wavelength of at least one transmission port based on destination information of the converted first frame, wherein the communicator is configured to transmit the first frame to the destination node through a relay configured to classify an optical signal for each wavelength between the predetermined number of the node groups and relay the optical signal to a destination.

The transmission port may be classified based on the destination group to which the first frame is able to be transmitted.

The communicator may be configured to change the output optical wavelength of the transmission port based on at least one of an input and output relationship for each optical wavelength of the relay or a connection relationship between the first node, the destination node, and the relay.

A number of transmission ports may be identical to a number of the node groups in the network.

The communicator may be configured to transmit the first frame to the destination node using at least one time slot allocated to the first node in a time frame provided based on a synchronization clock and a counter reset signal commonly provided for each group or all groups.

The communicator may be configured to set a time slot, an optical wavelength, and the transmission port corresponding to the destination information based on a forwarding table of the first node, and transmit the first frame to the destination node based on the setting.

Each of the nodes may be connected to at least one of top of racks (TORs).

According to another aspect, there is provided a photonic frame processing apparatus including a communicator configured to receive a first frame in a photonic frame structure transmitted from a preset departure group corresponding to at least one reception port among a predetermined number of node groups in a network using the at least one reception port, and a processor configured to convert the first frame into a second frame in a data frame structure.

The processor may be configured to extract the first frame from a time slot of a time frame received from a relay configured to relay an optical signal between the predetermined number of the node groups.

A number of the reception ports may be identical to a number of the node groups in the network.

According to still another aspect, there is provided a method of processing a photonic frame including converting data received by a first node among a plurality of nodes included in a predetermined number of node groups in a network into a first frame in a photonic frame structure, and transmitting the first frame to a destination node of a destination group among the node groups by changing an output optical wavelength of at least one transmission port based on destination information of the converted first frame, wherein the transmitting of the first frame to the destination node includes transmitting the first frame to the destination node through a relay configured to classify an optical signal for each wavelength between the predetermined number of the node groups and relay the optical signal to a destination.

The transmitting of the first frame to the destination node may include transmitting the first frame to the destination node using at least one time slot allocated to the first node in a time frame provided based on a synchronization clock and a counter reset signal provided for each group or all groups.

The transmitting of the first frame to the destination node may include setting a time slot, an optical wavelength, and the transmission port corresponding to the destination information based on a forwarding table of the first node, and transmitting the first frame to the destination node based on the setting.

The transmission port may be classified based on the destination group to which the first frame is able to be transmitted.

The transmitting of the first frame to the destination node may include changing the output optical wavelength of the transmission port based on at least one of an input and output relationship for each optical wavelength of the relay or a connection relationship between the first node, the destination node, and the relay.

A number of transmission ports may be identical to a number of the node groups in the network.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating a photonic frame processing apparatus according to an example embodiment;

FIG. 2 illustrates a connection relationship and grouping of a plurality of nodes included in a network according to an example embodiment;

FIG. 3 illustrates a connection relationship between a plurality of node groups in a network according to an example embodiment;

FIG. 4 illustrates a process of transmitting a photonic frame in a network provided by extending a node group according to an example embodiment;

FIG. 5 illustrates a method of providing a common synchronization clock and a common counter reset signal for each group according to an example embodiment;

FIG. 6 illustrates a method of using a time slot of a time frame commonly provided for each group according to an example embodiment;

FIG. 7 is a forward table referred to in a process of transmitting a photonic frame according to an example embodiment;

FIGS. 8A and 8B each illustrate a process of transmitting a photonic frame in an intersecting method according to an example embodiment; and

FIG. 9 is a flowchart illustrating a method of processing a photonic frame according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Terms such as first, second, A, B, (a), (b), and the like may be used herein to describe components. Each of these terminologies is not used to define an essence, order or sequence of a corresponding component but used merely to distinguish the corresponding component from other component(s). For example, a first component may be referred to a second component, and similarly the second component may also be referred to as the first component.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, examples are described in detail with reference to the accompanying drawings. Like reference numerals in the drawings denote like elements, and a known function or configuration will be omitted herein.

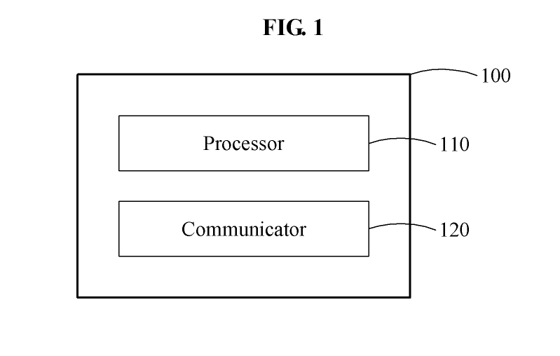

FIG. 1 is a block diagram illustrating a photonic frame processing apparatus 100 according to an example embodiment.

The photonic frame processing apparatus 100 is a device for transmitting and receiving a photonic frame in a form of an optical signal via a network in a data center. The photonic frame processing apparatus 100 may increase energy efficiency and reduce a network delay time while maintaining connection compatibility with a server or a terminal. The photonic frame processing apparatus 100 includes a processor 110 and a communicator 120.

When the photonic frame processing apparatus 100 operates to transmit a photonic frame, the processor 110 may convert data received by a first node among a plurality of nodes included in a predetermined number of node groups in a network into a first frame in a photonic frame structure. The nodes may be understood as apparatuses for converting electric signal data into optical signal data, and photonic frame wrapper line interface board assemblies (PWIAs) being boards including transmission/reception ports that transmit and receive converted optical signal data. Also, the nodes may be managed and grouped as a predetermined number of groups in the network.

Each of the nodes may be connected to at least one of top of racks (TORs). Hereinafter, a TOR is also referred to as a TOR apparatus. The first node among the nodes may transmit data received from TORs connected to the first node to a node connected to destination TORs. In this process, the processor 110 may receive a data frame in a form of an electric signal from the TORs and convert the data frame into a photonic frame (optical frame) in a form of an optical signal, and then transmit the converted photonic frame to a destination node of a destination group among the predetermined number of the node groups through the communicator 120. Each of the nodes includes transmission ports of which a number is identical to a number of the node groups in the network, and the transmission ports may be classified based on a destination group to which a first frame is able to be transmitted. The destination node may be a node belonging to a node group different from that of the first node, or may be a node belonging to a same node group of the first node. In an example, the first node and the destination node may be identical. In this example, the converting from the data frame into the photonic frame may be omitted.

The communicator 120 may transmit the first frame to the destination node of the destination group among the node groups by changing an output optical wavelength of at least one transmission port based on destination information of the converted first frame. The communicator 120 may transmit the first frame to the destination node through a relay configured to classify the optical signal for each wavelength between the predetermined number of the node groups and relay the optical signal to a destination. For this, the communicator 120 may change the output optical wavelength of the transmission port based on at least one of an input and output relationship for each optical wavelength of the relay or a connection relationship between the first node, the destination node, and the relay. Here, the relay may be understood as an arrayed wavelength gating router (AWGR) used for wavelength multiplexing or demultiplex routing.

In addition, the communicator 120 may transmit the first frame to the destination node using at least one time slot allocated to the first node in a time frame provided based on the synchronization clock and the counter reset signal provided for each group or all groups. In this process, the communicator 120 may set a time slot, an optical wavelength, and a transmission port corresponding to the destination information based on a forwarding table of the first node, and may transmit the first frame to the destination node based on the setting.

When the photonic frame processing apparatus 100 operates to receive the photonic frame, the communicator 120 may receive the first frame in the photonic frame structure transmitted from a preset destination group corresponding to at least one reception port among the predetermined number of the node groups in the network using the at least one reception port. A number of reception ports is identical to the number of the node groups in the network. In addition, the processor 110 may extract the first frame from the time slot of the time frame transmitted from a relay configured to relay the optical signal between the predetermined node groups, convert the extracted first frame into a second frame in a data frame structure, and then transmit the second frame to linked TORs.

The photonic frame processing apparatus 100 may manage nodes of the network in the data center in the predetermined number of the node groups and relay the photonic frame through the relay that connects the node groups such that expandability of the network and the energy efficiency may increase at a relatively low cost while maintaining the connection compatibility with a server and a terminal.

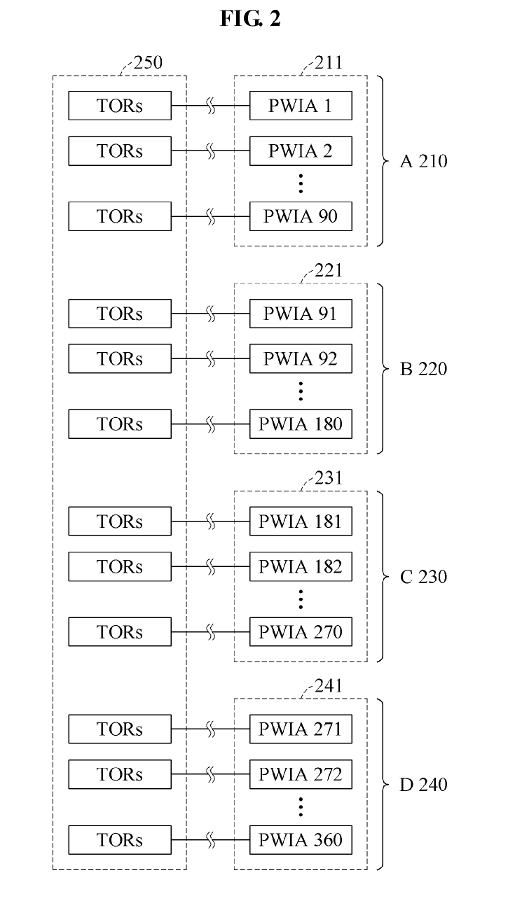

FIG. 2 illustrates a connection relationship and grouping of a plurality of nodes included in a network according to an example embodiment.

Referring to FIG. 2, the plurality of nodes may be understood as a plurality of photonic frame wrapper line interface board assemblies (PWIAs), hereinafter referred to as PWs. A plurality of PWs 211, 221, 231, and 241 are managed in units of a predetermined number of groups 210, 220, 230, and 240 in order to implement optical networking with relatively high expandability.

Each of the PWs 211, 221, 231, and 241 is connected to at least one of top of racks (TORs) 250. Each of the PWs 211, 221, 231, and 241 converts a data frame in an electric signal form transmitted from the TORs 250 into a photonic frame in an optical signal form and transmits the photonic frame to destination PWs connected to destination TORs through optical networking. The destination PWs 211, 221, 231, and 241 receiving the photonic frame may convert the photonic frame into the data frame in the electric signal form, and transmit the data frame to the destination TORs 250 through own TOR links.

The TORs 250 may transmit data of an apparatus group including at least one server or a data processing apparatus to the PWs 211, 221, 231, and 241 of which links are set, and transmit the data frame received from the PWs 211, 221, 231, and 241 to a destination server or the data processing apparatus. The TORs 250 may be included in the PWs 211, 221, 231, and 241, or may be separated from the PWs 211, 221, 231, and 241. Each of the PWs 211, 221, 231, and 241 may be connected to the at least one of the TORs 250 through TOR connection ports, and may relay the data transmitted and received between the TORs 250.

The PWs 211, 221, 231, and 241 may transmit the data based on destination information of the data frame input from the at least one of the TORs 250 of which the links are set. Here, when a destination of the data frame corresponds to at least one of the TORs 250 connected to an identical PW, the data frame may be transmitted through a TOR connection port linked to a destination TOR without performing optical conversion. However, when the destination of the data frame corresponds to at least one of the TORs 250 connected to a different PW, the input data frame may be converted into the photonic frame and then transmit the photonic frame to a destination through a transmission port. However, according to an example, the data frame may be received through optical networking through photonic frame conversion and a transmitting process even when the destination of the data frame corresponds to the at least one of the TORs 250 of the identical PW.

Each of the PWs 211, 221, 231, and 241 may be selected as a subnet. When the PWs 211, 221, 231, and 241 receive the data frame from the TORs 250, a subnet to which the destination information of the data frame belongs may be obtained and the PWs 211, 221, 231, and 241 corresponding to the subnet may be verified. In another example, a subnet may be obtained for each of the TOR connection ports of the PWs 211, 221, 231, and 241, and the PWs 211, 221, 231, and 241 may be implemented based on a method of obtaining a subnet to which the destination information of the data frame belongs when the data frame is received from the TORs 250 and verifying PWs to which the connection port and the TOR connection port corresponding to the subnet belong.

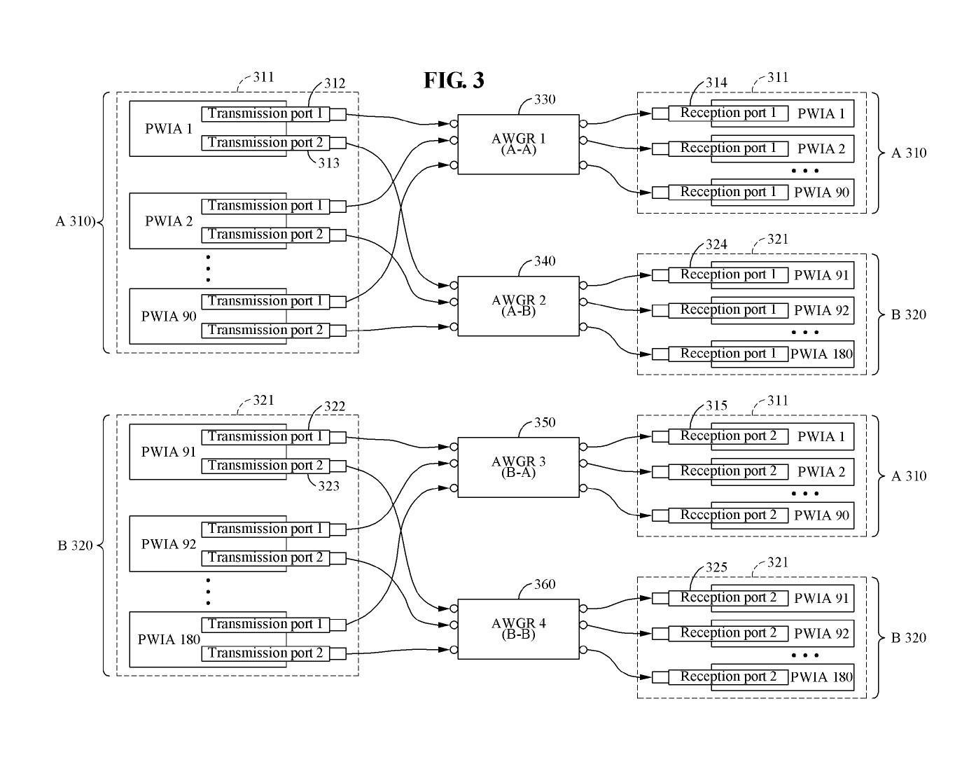

FIG. 3 illustrates a connection relationship between a plurality of node groups in a network according to an example embodiment.

Referring to FIG. 3, groups 310 and 320 each including a plurality of PWs are connected through arrayed wavelength gating routers (AWGRs) 330, 340, 350, and 360 that relay a photonic frame. Optical signal transmission ports 312, 313, 322, and 323 of a plurality of PWs 311 and 321 are classified based on a destination group 310 or 320. The photonic frame transmitted from a predetermined group, for example, the group 310 or 320, may be received through optical reception ports 314, 315, 324, and 325 of the PWs 311 and 321.

FIG. 3 illustrates a process of an optical networking process for grouping 90 PWs 311 and 321 to the group A 310 and the group B 320, and relaying a photonic frame transmitted and received between the group A and the group B by connecting the group A and the group B through four AWGRs 330, 340, 350, and 360. A number of the optical signal transmission ports 312, 313, 322, and 323 and a number of the reception ports 314, 315, 324, and 325 used for optical networking by the PWs 311 and 321 are identical to a number of groups of the PWs 310 and 320. The optical signal transmission ports 312, 313, 322, and 323 of the PWs 311 and 321 are classified based on a destination group, and the optical signal reception ports 314, 315, 324, and 325 may receive the photonic frame of the predetermined group, for example, the group 310 or 320.

In a case of the optical signal transmission ports 312, 313, 322, and 323, the photonic frame may be transmitted to a destination by changing an optical wavelength used to output an optical signal. In this process, the PWs 311 or 321 to transmit the photonic frame may transmit the photonic frame to a destination PW of a destination group by changing an output optical wavelength of a transmission port based on an input and output relationship for each optical wavelength of the AWGRs 330, 340, 350, and 360, and relationships between departure/destination PWs and AWGRs 330, 340, 350, and 360.

Because output ports of the AWGRs 330, 340, 350, and 360 are different depending on wavelengths of optical signals to be input, the optical signals may be classified for each wavelength and transmitted to each of the output ports when the optical signals having multiple wavelengths are simultaneously input to one input port.

In FIG. 3, the PWs 311 of the group A 310 on a transmission side and the PWs 311 of the group A 310 on a reception side transmit and receive the photonic frame through the AWGR 330. The PWs 311 of the group A 310 and the PWs 321 of the group B transmit and receive the photonic frame through the A to B AWGR 340. Also, the PWs 321 of the group B 320 and the PWs 311 of the group A 310 transmit and receive the photonic frame through the B to A AWGR 350, and the PWS 321 of the group B 320 on the transmission side and the PWs 321 of the group B 320 on the reception side transmit and receive the data frame through the B to B AWGR 360.

When destination PWs correspond to the PWs 311, the PWs 311 of the group A 310 may transmit the photonic frame using the first transmission port 312. When the destination PWs correspond to the PWs 321 of the group B 320, the photonic frame may be transmitted using the second transmission port 313. Here, the PWs 311 may allow the photonic frame to reach the destination PWs 311 and 321 of the group A 310 and the group B 320 by changing output optical wavelengths of the transmission ports 312 and 321 based on the input and output relationship for each optical wavelength of the AWGRs 330 and 340, and relationships between the departure/destination PWs 311 and 321 and the AWGRs 330 and 340.

Similarly, when the destination PWs correspond to the PWs 311 of the group A 310, the PWs 321 of the group B 320 may transmit the photonic frame using the first transmission port 322. When the destination PWs correspond to the PWs 321 of the group B 320, the photonic frame may be transmitted using the second transmission port 323. Here, the PWs 321 may allow the photonic frame to reach the destination PWS 311 and 321 of the group A 310 and the group B 320 by changing output optical wavelengths of the transmission ports 322 and 323 based on the input and output relationship for each optical wavelength of the AWGRs 350 and 360, and relationships between the departure/destination PWs 311 and 321 and the AWGRs 350 and 360. The PWs 311 and 321 may receive the photonic frame transmitted by the PWs 311 of the group A 310 through the first reception transmission ports 314 and 324, and receive the photonic frame transmitted by the PWs 321 of the group B 320 through the second reception ports 315 and 325.

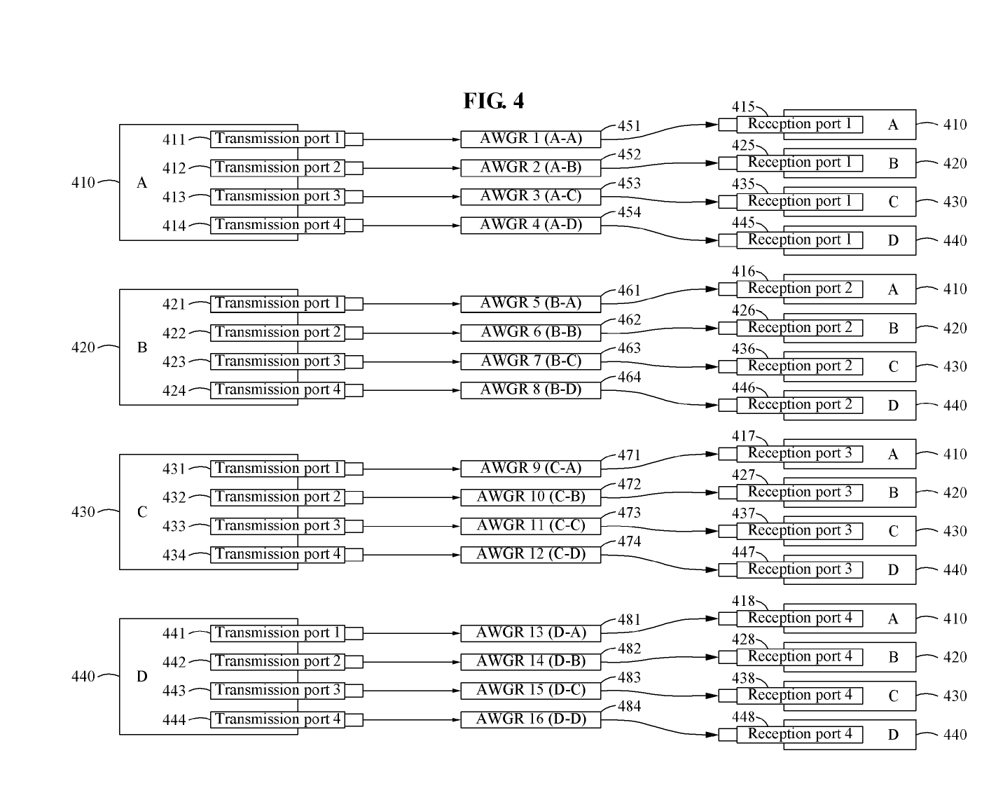

FIG. 4 illustrates a process of transmitting a photonic frame in a network provided by extending a node group according to an example embodiment.

FIG. 4 illustrates an example of extending a plurality of PWs to a group A 410, a group B 420, a group C 430, and a group D 440, and relaying a photonic frame transmitted and received by connecting the four groups 410, 420, 430, and 440 using AWGRs 451 through 454, 461 through 464, 471 through 474, and 481 through 484.

The PWs of the group A 410 on a transmission side and the PWs of the group A 410 on a reception side are connected through the first AWGR 451, and the PWs of the group A 410 on the transmission side and the PWs of the group B 420 on the reception side are connected through the second AWGR 452. The PWs of the group A 410 on the transmission side and the PWs of the group C 430 on the reception side are connected through the third AWGR 453, and the PWs of the group A 410 on the transmission side and the PWs of the group D 440 on the reception side are connected through the fourth AWGR 454.

The PWs of the group B 420 on the transmission side and the PWs of the group A 410 on the reception side are connected through the fifth AWGR 461, and the PWs of the group B 420 on the transmission side and the PWs of the group B 420 on the reception side are connected through the sixth AWGR 462. The PWs of the group B 420 on the transmission side and the PWs of the group C 430 on the reception side are connected through the seventh AWGR 463, and the PWs of the group B 420 on the transmission side and the PWs of the group D on the reception side are connected through the eighth AWGR 464.

In the case of the group C 430, the ninth AWGR 471 is used for a connection with the PWs of the group A 410, the tenth AWGR 472 is used for a connection with the PWs of the group B 420, the eleventh AWGR 473 is used for a connection with the PWs of the group C 430, and the twelfth AWGR 474 is used for a connection with the group D 440.

Similarly, in a case of the group D 440, the thirteenth AWGR 481 is used for a connection with the PWs of the group A 410, the fourteenth AWGR 482 is used for a connection with the PWs of the group B420, the fifteenth AWGR 483 is used for a connection with the PWs of the group C 430, and the sixteenth AWGR 484 is used for a connection with the PWs of the group D 440.

Each PW may transmit the photonic frame using the first transmission ports 411, 421, 431, and 441 when destination PWs correspond to the PWs of the group A 410, and the photonic frame is transmitted using the second transmission ports 412, 422, 432, and 442 when the destination PWs correspond to the PWs of the group B 420. In addition, when the destination PWs correspond to the PWs of the group C 430, the photonic frame is transmitted using the third transmission ports 413, 423, 433, and 443, and the photonic frame is transmitted using the fourth transmission ports 414, 424, 434, and 444 when the destination PWs correspond to the PWs of the group D 440.

Wavelengths of the transmission ports 411 through 414, 421 through 424, 431 through 434, and 441 through 444 used to output an optical signal may be changed based on an input and output relationship of the AWGRs 451 through 454, 461 through 464, 471 through 474, and 481 through 484, and relationships between departure/destination PWs and AWGRs.

Each PW may receive the photonic frame transmitted by the PWs of the group A 410 through first reception ports 415, 425, 435, and 445, receive the photonic frame transmitted by the PWs of the group B 420 through second reception ports 416, 426, 436, and 446, receive the photonic frame transmitted by the PWs of the group C 430 through third reception ports 417, 427, 437, and 447, and receive the photonic frame transmitted by the PWs of the group D 440 through fourth reception ports 418, 428, 438, and 448.

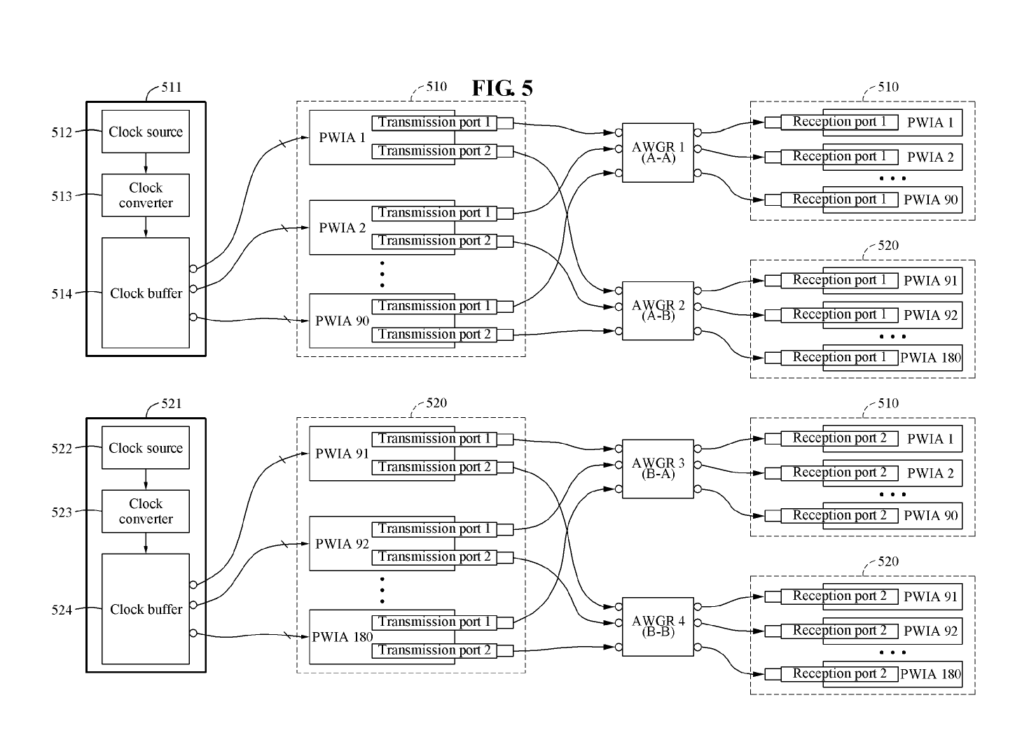

FIG. 5 illustrates a method of providing a common synchronization clock and a common counter reset signal for each group according to an example embodiment.

A group A 510 and a group B 520 include a common time frame used for each group or all groups using a synchronization clock and a counter reset signal commonly provided for each PW group or all PW groups through clock suppliers 511 and 521. A transmission PW may transmit a photonic frame to a destination using a predetermined time slot of the time frame, and a reception PW may extract an optical frame from the time slot of the time frame.

The clock suppliers 511 and 521 may be present in each PW group to supply the synchronization clock and the counter reset signal, or one clock supplier may be provided for all groups to commonly supply the synchronization clock and the counter reset to all groups. When the clock suppliers 511 and 521 are used for each group, the time frame may be provided for each group. However, when one clock supplier is used for all groups, the common time frame may be provided for all groups. The clock suppliers 511 and 521 may be separated from PW groups, for example, the group A 510 and the group B 520, or may be included in the PW groups.

The clock suppliers 511 and 521 include respective clock sources 512 and 522, respective clock converters 513 and 523, and respective clock buffers 514 and 524. The clock suppliers 511 and 521 may provide the synchronization clock and the counter reset signal for each PW group through clock lines connected to each group. In this process, the clock sources 512 and 522 may provide a source clock for generating the synchronization clock and the counter reset signal, and output the counter reset signal for each predetermined number of synchronization clocks by outputting and converting the source clock into a synchronization clock required by the PW. Also, the clock buffers 514 and 524 may generate one synchronization clock and a plurality of counter reset signals to be provided for each PW group or all PW groups.

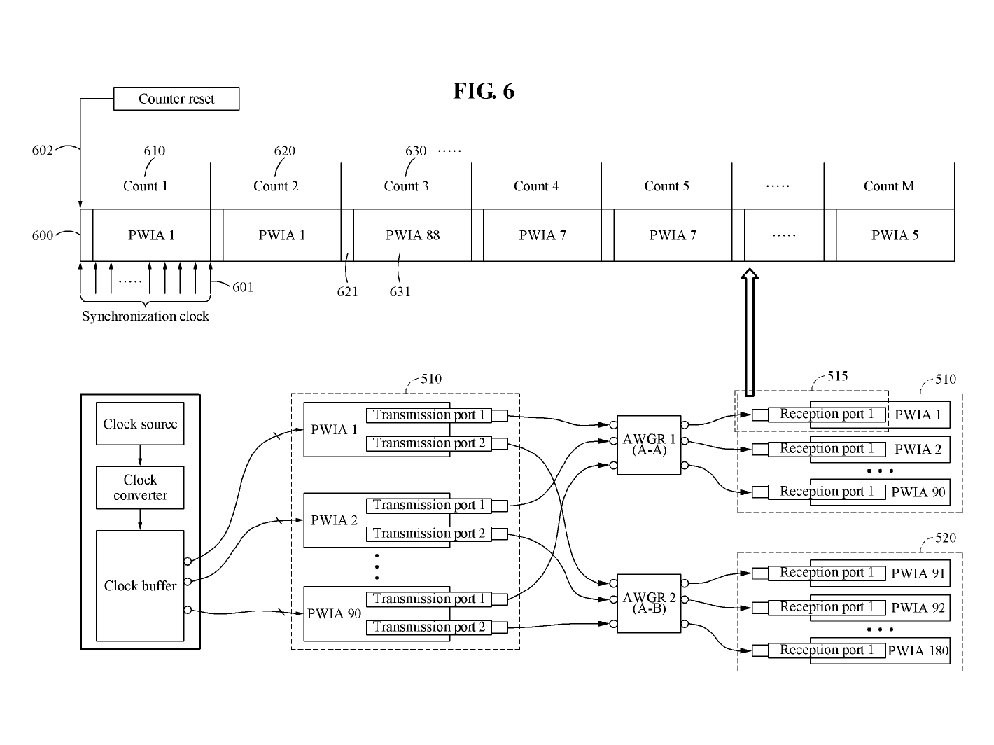

FIG. 6 illustrates a method of using a time slot of a time frame commonly provided for each group according to an example embodiment.

A common time frame used for each group or all groups may be provided in the PW groups 510 and 520 using a synchronization clock 601 and a counter reset signal 602 commonly provided for each group or all groups. FIG. 6 illustrates a time frame 600 of a first reception port (reception ports 515 of PW 1 that receives photonic frame transmitted from group A) of the first PW.

The PWs of the group A 510 on a transmission side may transmit a photonic frame through time slots 610, 620, 630 through M allocated to the PWs of the group A 510 on the transmission side in the time frame 600 of the reception ports 515. For example, a PW 1 may transmit the photonic frame to the first time slot 610 and the second time slot 620, and a PW 88 may transmit the photonic frame to the third time slot 630. The time frame 600 may be managed for each reception ports 515 of the PWs. When the PWs of the group A 510 on the transmission side know destination PWs, for example, the group 510 or 520, the photonic frame may be transmitted through the time slots 610, 620, 630 through M for the reception ports 515 of corresponding destination PWs.

A configuration of time slots 610 through 630 of the time frame 600 may be selected in advance, or dynamically selected based on destination PWs verified by receiving data frame from TORs. Also, in the time frame 600, a time gap 621 may be provided between the time slots 610, 620, 630 through M to compensate for a difference in the synchronization clock 601 received by the PWs, and the PWs on the transmission side may transmit valid data 631 subsequent to the time gap 621.

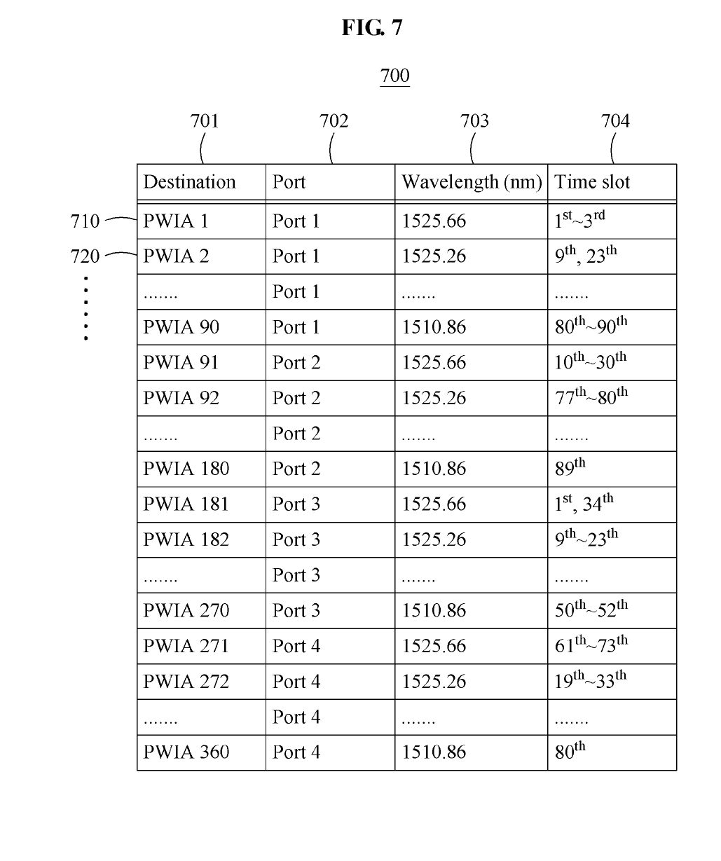

FIG. 7 is a forward table 700 referred to in a process of transmitting a photonic frame according to an example embodiment.

The forwarding table 700 included in each of PWs includes information about a destination 702, an optical signal output port 702, an optical wavelength 703, and a time slot 704 required for transmitting a photonic frame. The PWs may transmit the photonic frame by selecting the optical signal output port 702, the optical wavelength 703, and the time slot 704 corresponding to destination PWs based on the forwarding table 700.

When a photonic frame wrapper is (PFWI, hereinafter referred to as a PF) of a PW obtains a destination PW based on destination information of a data frame, the optical signal output port 702, the optical wavelength 703, and the time slot 704 corresponding to the destination PW may be selected based on the forwarding table 700. When the PW receives the data frame from a TOR, the destination information of the data frame may be extracted to obtain the destination 701, forwarding entries 710, 720, . . . including the destination information identical to that of the destination 701 may be found based on the forwarding table 700, and the optical signal output port 702, the optical wavelength 703, and the time slot 704 enrolled in corresponding forwarding entries. The PW may convert the data frame into a photonic frame, and transmit the photonic frame through the optical signal output port 702 verified based on a searching result of the forwarding table 700. Here, the PW may set the optical wavelength 703 obtained based on the searching result of the forwarding table 700 as an output wavelength of the optical signal output port 702, and transmit the photonic frame through the time slot 704 verified based on the searching result of the forwarding table 700.

The information about the optical signal output port 702 and the optical wavelength 703 of the forwarding table 700 may be determined based on a connection relationship between an optical transmission port, an optical signal reception port, and an AWGR that relays PW groups in a network. Also, a value of the time slot 704 of the forwarding table 700 may be set in advance based on a configuration of a predetermined time frame, or set by dynamically receiving a time slot required whenever the data frame is received from the TOR.

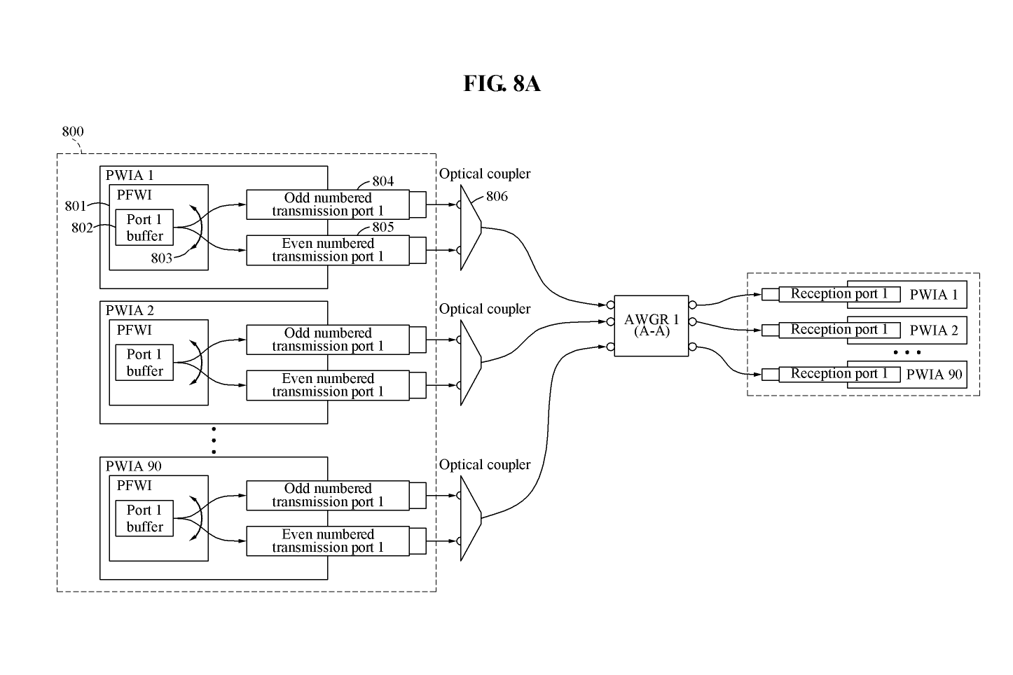

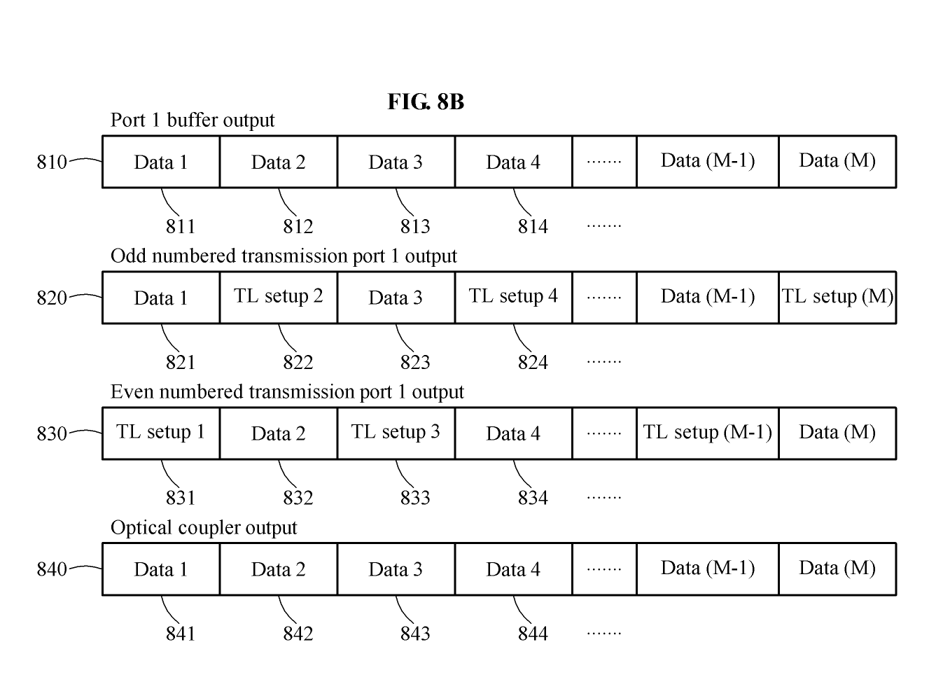

FIGS. 8A and 8B each illustrate a process of transmitting a photonic frame in an intersecting method according to an example embodiment. FIG. 8A illustrates a process of transmitting the photonic frame through first transmission ports based on the intersecting method, and FIG. 8B illustrates time frame output states in a port 1 buffer 802, a first odd numbered transmission port 804, a first even numbered transmission port 805, and an optical coupler 806 in the process of transmitting the photonic frame.

A PW 800 includes a plurality of transmission ports 804 and 805. A PF 801 in the PW 800 may transmit the photonic frame to time slots (time slots 821 through 824, and 831 through 834 of FIG. 8B) classified for each of the transmission ports 804 and 805 through the corresponding transmission ports 804 and 805, and the optical coupler 806 may collect optical signals of the transmission ports 804 and 805 and transmit the optical signals to an AWGR.

The PF 801 may convert a data frame received from a TOR into a photonic frame, and transmit an optical frame corresponding to a time frame of a transmission port. Here, the port 1 buffer 802 of the PF 801 may perform an output interleaving 803 on the time frame (time frame 810 of FIG. 8B) of the first transmission port, an odd numbered time slot may output the optical frame through the first odd numbered transmission port 804, and an even numbered time slot may output the optical frame through the first even numbered transmission port 805. As a result, valid data may be present in the odd numbered time slots 821 and 823 in the output time frame 820 of the first odd numbered transmission port 804, and valid data may be present in the even numbered time slots 832 and 834 in the output time frame 830 of the first even numbered transmission port 805. The time slots 822, 824, 831, and 833 not including the valid data in the time frame 820 of the first odd numbered transmission port and the time frame 830 of the first even numbered transmission port may be used as times for changing (for example, output wavelength converting) setting of the first odd numbered transmission port 804 and the first even numbered transmission port 805.

The optical coupler 806 may collect optical signals of the first odd numbered transmission port 804 and the first even numbered transmission port 805 to be transferred to an AWGR 1. As a result, the time slots 841 through 844 of the output time frame 840 of the optical coupler 806 may be identically provided to the time slots 811 through 814 of the output time frame 810 of a port 1 buffer.

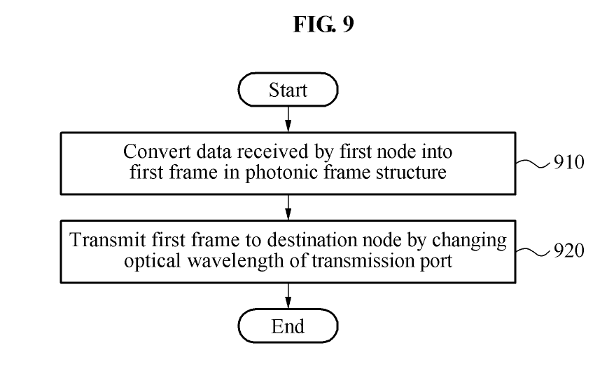

FIG. 9 is a flowchart illustrating a method of processing a photonic frame according to an example embodiment.

A photonic frame processing apparatus provides a method of transmitting and receiving a photonic frame in a form of an optical signal through a network in a data center.

In operation 910, a processor of the photonic frame processing apparatus converts data received by a first node among a plurality of nodes included in a predetermined number of node groups in the network into a first frame in a photonic frame structure. Here, the nodes may be understood as photonic frame wrapper line interface board assemblies (PWIAs) included in the network, and may be managed and grouped as a predetermined number of groups in the network. Each of the nodes may be connected to at least one of top of racks (TORs), and the data received from the TOR connected to the first node among the nodes may be transmitted to a node connected to a destination TOR.

In operation 910, the processor converts a data frame in a form of an electric signal into a photonic frame in a form of an optical signal by receiving the data frame from the TORs, and transmits the converted first frame in the photonic frame structure to a destination node of a destination group among the predetermined number of the node groups. The destination node may be a node belonging to a node group different from that of the first node, or may be a node belonging to a same node group of the first node. In an example, the first node and the destination node may be identical. In this example, the converting from the data frame into the photonic frame may be omitted.

In operation 920, a communicator of the photonic frame processing apparatus may transmit the first frame to the destination node of the destination group among the node groups by changing an output optical wavelength of at least one transmission port based on destination information of the converted first frame. A number of transmission ports may be identical to a number of the node groups, and may be classified based on the destination group to which the first frame is able to be transmitted.

In operation 920, the communicator may transmit the first frame to the destination node through a relay configured to classify an optical signal for each wavelength between the predetermined number of the node groups and relay the optical signal to a destination. For this, the communicator 120 may change the output optical wavelength of the transmission port based on at least one of an input and output relationship for each optical wavelength of the relay or a connection relationship between the first node, the destination node, and the relay. Here, the relay may be understood as an arrayed wavelength gating router (AWGR) used for wavelength multiplexing or demultiplex routing. In addition, in operation 920, the communicator may transmit the first frame to the destination node using at least one time slot allocated to the first node in a time frame provided based on the synchronization clock and the counter reset signal provided for each group or all groups. In this process, the communicator may set a time slot, an optical wavelength, and a transmission port corresponding to the destination information based on a forwarding table of the first node, and may transmit the first frame to the destination node based on the setting.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A photonic frame processing apparatus comprising:
a processor configured to convert data received by a first node among a plurality of nodes included in a predetermined number of node groups in a network into a first frame in a photonic frame structure; and
a communicator configured to transmit the first frame to a destination node of a destination group among the node groups by changing an output optical wavelength of at least one transmission port based on destination information of the converted first frame,
wherein the communicator is configured to transmit the first frame to the destination node through a relay configured to classify an optical signal for each wavelength between the predetermined number of the node groups and relay the optical signal to a destination.

2. The photonic frame processing apparatus of claim 1, wherein the transmission port is classified based on the destination group to which the first frame is able to be transmitted.

3. The photonic frame processing apparatus of claim 1, wherein the communicator is configured to change the output optical wavelength of the transmission port based on at least one of an input and output relationship for each optical wavelength of the relay or a connection relationship between the first node, the destination node, and the relay.

4. The photonic frame processing apparatus of claim 1, wherein a number of transmission ports is identical to a number of the node groups in the network.

5. The photonic frame processing apparatus of claim 1, wherein the communicator is configured to transmit the first frame to the destination node using at least one time slot allocated to the first node in a time frame provided based on a synchronization clock and a counter reset signal commonly provided for each group or all groups.

6. The photonic frame processing apparatus of claim 1, wherein the communicator is configured to set a time slot, an optical wavelength, and the transmission port corresponding to the destination information based on a forwarding table of the first node, and transmit the first frame to the destination node based on the setting.

7. The photonic frame processing apparatus of claim 1, wherein each of the nodes is connected to at least one of top of racks (TORs).

8. A photonic frame processing apparatus comprising:
a communicator configured to receive a first frame in a photonic frame structure transmitted from a preset departure group corresponding to at least one reception port among a predetermined number of node groups in a network using the at least one reception port; and
a processor configured to convert the first frame into a second frame in a data frame structure.

9. The photonic frame processing apparatus of claim 8, wherein the processor is configured to extract the first frame from a time slot of a time frame received from a relay configured to relay an optical signal between the predetermined number of the node groups.

10. The photonic frame processing apparatus of claim 8, wherein a number of the reception ports is identical to a number of the node groups in the network.

11. A method of processing a photonic frame, the method comprising:
converting data received by a first node among a plurality of nodes included in a predetermined number of node groups in a network into a first frame in a photonic frame structure; and
transmitting the first frame to a destination node of a destination group among the node groups by changing an output optical wavelength of at least one transmission port based on destination information of the converted first frame,
wherein the transmitting of the first frame to the destination node comprises transmitting the first frame to the destination node through a relay configured to classify an optical signal for each wavelength between the predetermined number of the node groups and relay the optical signal to a destination.

12. The method of claim 11, wherein the transmitting of the first frame to the destination node comprises transmitting the first frame to the destination node using at least one time slot allocated to the first node in a time frame provided based on a synchronization clock and a counter reset signal provided for each group or all groups.

13. The method of claim 11, wherein the transmitting of the first frame to the destination node comprises setting a time slot, an optical wavelength, and the transmission port corresponding to the destination information based on a forwarding table of the first node, and transmitting the first frame to the destination node based on the setting.

14. The method of claim 11, wherein the transmission port is classified based on the destination group to which the first frame is able to be transmitted.

15. The method of claim 14, wherein the transmitting of the first frame to the destination node comprises changing the output optical wavelength of the transmission port based on at least one of an input and output relationship for each optical wavelength of the relay or a connection relationship between the first node, the destination node, and the relay.

16. The method of claim 1, wherein a number of transmission ports is identical to a number of the node groups in the network.
